(19) United States
(12) Patent Application Publication
(10) Pub. No.: US 2026/0117662 A1
(43) Pub. Date: Apr. 30, 2026

(54) CMC AIRFOIL PLATFORM ISO-GRID REINFORCEMENT

(71) Applicant: RTX Corporation, Farmington, CT (US)

(72) Inventors: Russell KIM, Temecula, CA (US); Thiago B. Vieira, Sarasota, FL (US); Kevin L. RUGG, East Hartford, CT (US); Samuel Enrique VARGAS VEGA, Palm City, FL (US)

(73) Assignee: RTX Corporation, Farmington, CT (US)

(21) Appl. No.: 19/217,169

(22) Filed: May 23, 2025

Related U.S. Application Data
(60) Provisional application No. 63/651,930, filed on May 24, 2024.

(51) Int. Cl. F01D 5/28; F01D 5/14

(52) U.S. Cl. CPC F01D 5/282; F01D 5/147; F01D 5/284; F05D 2240/80; F05D 2300/6033

(57) ABSTRACT

A gas turbine engine component may include an airfoil; at least one platform that may include a first exterior surface and a second opposing exterior surface, the airfoil is disposed in contact with the first exterior surface; and, at least one iso-grid reinforcement member disposed in contact with the second opposing exterior surface, the at least one iso-grid reinforcement member may include at least one aperture having a geometric shape or a non-geometric shape or a combination thereof.

### CROSS REFERENCE TO RELATED APPLICATIONS

This application claims the benefit of U.S. Provisional Patent Application No. 63/651,930 filed on May 24, 2024, which is hereby incorporated by reference for all purposes as if fully set forth herein.

### FIELD OF THE INVENTION

The subject matter disclosed herein relates to ceramic matrix composite (“CMC”) airfoils and, in particular, to the iso-grid reinforcement of a CMC airfoil platform.

### BACKGROUND OF THE INVENTION

Platform overhangs of CMC airfoils of both blades and vanes are essentially cantilevered features susceptible to bending under loads and vibratory response. Due to costs and engineering/design considerations, modifying the CMC airfoils in general, and their platforms specifically, to reduce bending and/or lessen vibrations can be problematic. For instance, when increasing the number of pieces constituting a blade or vane, more handling operations during assembly or disassembly become necessary. In turn, assembly and disassembly times increase, as well as the associated costs.

### SUMMARY OF THE INVENTION

The present disclosure is directed, in a first aspect, to a gas turbine engine component. The gas turbine engine component may include an airfoil and at least one platform comprising a first exterior surface and a second opposing exterior surface. The airfoil may be disposed in contact with the first exterior surface. At least one iso-grid reinforcement member may be disposed in contact with the second opposing exterior surface. And, at least one iso-grid reinforcement member may include at least one aperture having a geometric shape or a non-geometric shape or a combination thereof.

In yet another embodiment, the present disclosure is directed to a gas turbine engine component. The gas turbine engine component may include an airfoil and at least one platform having a first exterior surface and a second opposing exterior surface. The airfoil may be disposed in contact with the first exterior surface. And, at least one iso-grid reinforcement member in a preform state may be disposed in contact with the second opposing exterior surface.

In yet another embodiment, the present disclosure is directed to a gas turbine engine component. The gas turbine engine component may include a blade outer air seal. The blade outer air seal may include a body defining a gas flow path side, a non-gas flow path side opposite the gas flow path side, a forward end, an aft end, and at least one circumferential side. And, at least one iso-grid reinforcement member in a preform state may be disposed in contact with the non-gas flow path side.

In yet another embodiment, the present disclosure is directed to a method of manufacturing at least one iso-grid ply. At least one ply may be provided in a preform state. The preform state of at least one ply may include a ceramic matrix composite (CMC) material and a resin or a resinous material. Any one of the following steps may take place next. For example, in step (i), at least one aperture may be formed in each at least one ply in a preform state to form at least one iso-grid ply in a preform state. For example, in step (ii), at least one ply in a preform state may be arranged to form a stack of plies in a preform state. For example, in step (iii), at least one initial aperture may be formed in each at least one ply in a preform state. At least one initial aperture then may be refined to form at least one aperture. And, each at least one ply in a preform state then may be transformed into at least one iso-grid ply in a preform state. Next, any one of the following steps may take place. For example, after performing step (i) above, at least one iso-grid ply in a preform state may be arranged to form a stack of iso-grid plies in a preform state. For example, after performing step (ii) above, step (iia) may be performed. For instance, at least one aperture may be formed in at least one ply in a preform state of the stack of plies in a preform state to form at least one iso-grid ply in a preform state of a stack of iso-grid plies in a preform state. Or, for example, step (iib) may be performed. At least one initial aperture may be formed in each at least one ply in a preform state of the stack of plies in a preform state. At least one initial aperture may be refined to form at least one aperture. And, each at least one ply in a preform state of the stack of plies in a preform state then may be transformed into at least one iso-grid ply in a preform state of a stack of iso-grid plies in a preform state. Or, for example, after performing (iii), at least one iso-grid ply in a preform state may be arranged to form a stack of iso-grid plies in a preform state. And, optionally, at least one aperture of each at least one iso-grid ply in a preform state in the stack of iso-grid plies in a preform state may be refined.

In yet another embodiment, the present disclosure is directed to a method of manufacturing a gas turbine engine component. The gas turbine engine component may include an iso-grid reinforcement member. In carrying out the method, at least one iso-grid ply in a preform state or at least one partially densified iso-grid reinforcement member may be disposed in contact with at least one platform having an airfoil attached thereto to form an iso-grid reinforced gas turbine engine component. The iso-grid reinforced gas turbine engine component may be densified using at least one of or a combination of chemical vapor infiltration, chemical vapor deposition, polymer infiltration and pyrolysis, and melt infiltration, to form a densified iso-grid reinforced gas turbine engine component. The densified iso-grid reinforced gas turbine engine component may include at least one iso-grid reinforcement member. And, optionally, the densified iso-grid reinforced gas turbine engine component may be refined.

In yet another embodiment, the present disclosure is directed to a method of manufacturing a gas turbine engine component having an iso-grid reinforcement member. At least one iso-grid ply in a preform state or at least one partially densified iso-grid reinforcement member may be disposed in contact with at least one non-gas flow path side of at least one blade outer air seal to form an iso-grid reinforced gas turbine engine component. Next, the iso-grid reinforced gas turbine engine component may be densified using at least one of or a combination of chemical vapor infiltration, chemical vapor deposition, polymer infiltration and pyrolysis, and melt infiltration, to form a densified iso-grid reinforced gas turbine engine component. Next, the densified iso-grid reinforced gas turbine engine component may include at least one iso-grid reinforcement member. And, optionally, the densified iso-grid reinforced gas turbine engine component may be refined.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 illustrates a schematic, cross-sectional view of a gas turbine engine;

FIG. 2 illustrates a gas turbine engine component;

FIG. 3 illustrates another gas turbine engine component;

FIG. 4 illustrates yet another gas turbine engine component;

FIG. 5 illustrates an exemplary iso-grid reinforcement member;

FIG. 6 illustrates an exemplary iso-grid reinforcement member disposed in contact with a second opposing surface of a gas turbine engine component;

FIG. 7 illustrates a flowchart illustrating a method of manufacturing an exemplary iso-grid ply and an exemplary stack of plies of the exemplary iso-grid reinforcement member;

FIG. 8 illustrates a flowchart illustrating a method of manufacturing a gas turbine engine component using an exemplary iso-grid reinforcement member in a preform state; and

FIG. 9 illustrates a flowchart illustrating a method of manufacturing a gas turbine engine component using an exemplary iso-grid reinforcement member in an at least partially densified state.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art. It is to be understood that all concentrations disclosed herein are by weight percent (wt. %.) based on a total weight of the composition unless otherwise indicated.

The present disclosure is directed to an iso-grid reinforcement member comprising at least one ply, and disposed in contact with a surface of a platform of a gas turbine engine component. In particular, the iso-grid reinforcement member is disposed in contact with a surface of an overhang of the platform. The iso-grid reinforcement member disposed in contact with the overhang increases stiffness and minimizes mass to withstand loads and minimize vibratory responses during use. For instance, the iso-grid reinforcement member permits refining the platform, such as machining the platform, which decreases wall thickness and leads to reducing the platform's mass. In carrying out the exemplary methods disclosed herein, the iso-grid reinforcement member may be refined more efficiently and cost-effectively because the reinforcement member is in a preform state when being refined. In turn, reducing the platform's mass improves the platform's ability to withstand loads and minimize vibratory responses. In addition, the iso-grid reinforcement member improves densification by creating additional paths to the platform and minimizes the risk of poor densification due to an increase in the thickness of the platforms where the reinforcing structure is present. Moreover, in certain circumstances, the iso-grid reinforcement member may reduce thermal gradients in a platform that has undergone further reduction in thickness at unsupported locations, i.e., surface exposed by the aperture(s) of the iso-grid reinforcement member.

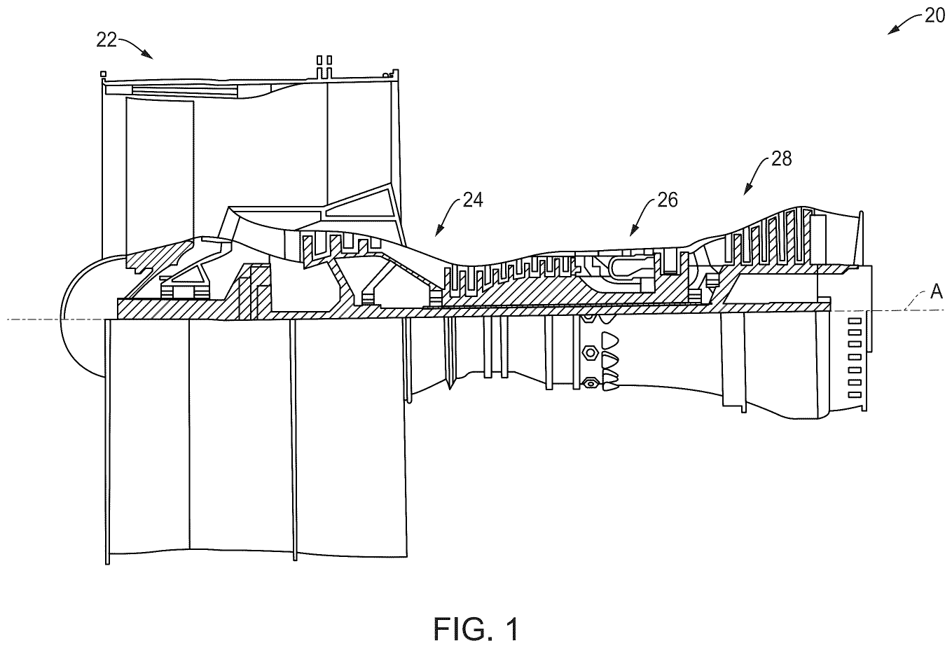

Referring now to FIG. 1, a gas turbine engine 20 is schematically illustrated. The exemplary gas turbine engine 20 is a two-spool turbofan engine that generally incorporates a fan section 22, a compressor section 24, a combustor section 26 and a turbine section 28 about an engine centerline longitudinal axis A. Alternative engines might include an augmenter section (not shown) among other systems for features. Although depicted as a turbofan gas turbine engine in the disclosed non-limiting embodiment, it should be understood that the concepts described herein are not limited to turbofan engines and these teachings could extend to other types of engines, including but not limited to, three-spool engine architectures.

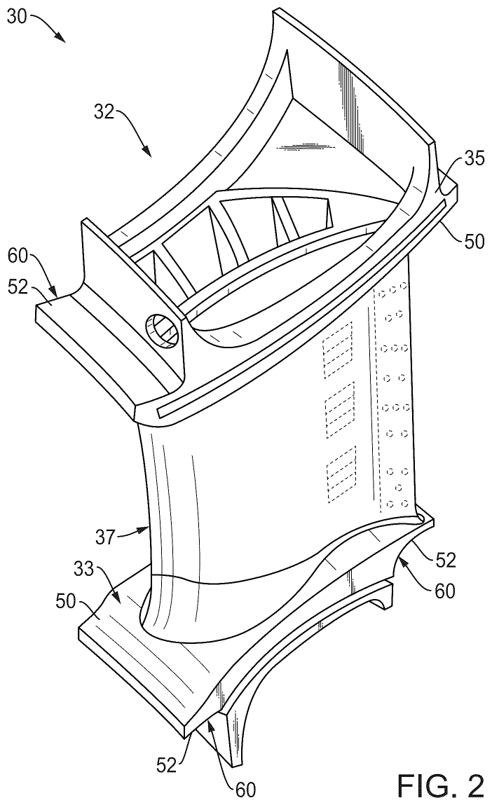

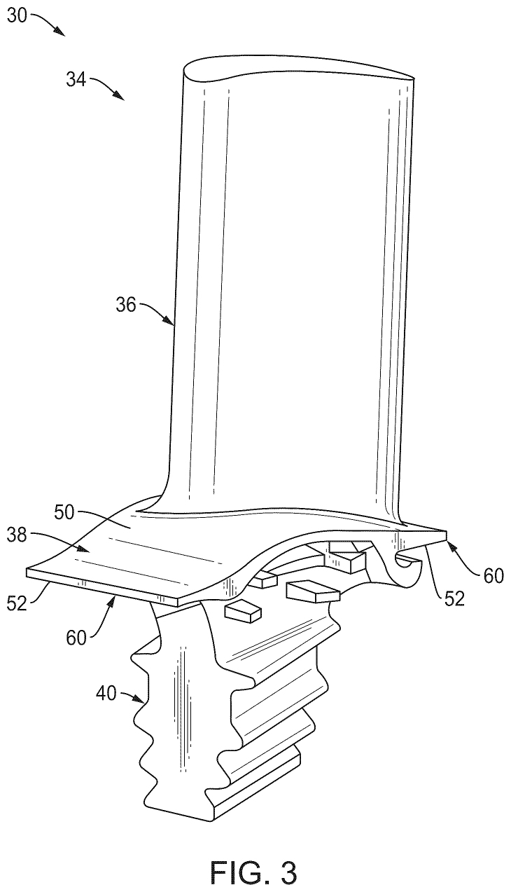

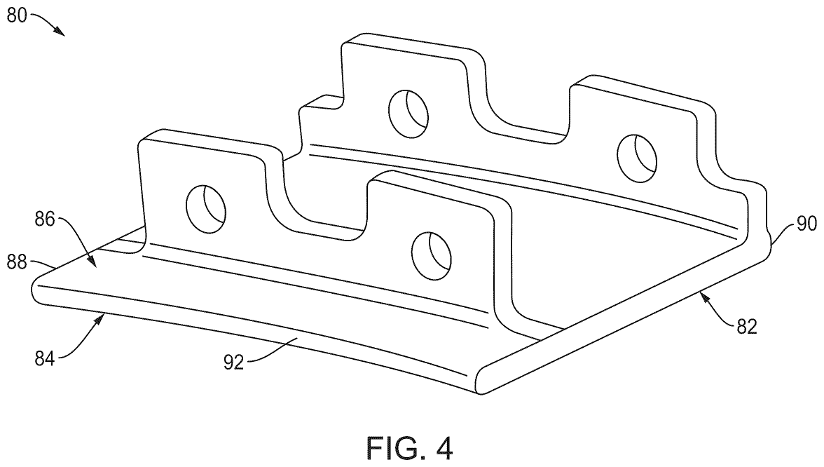

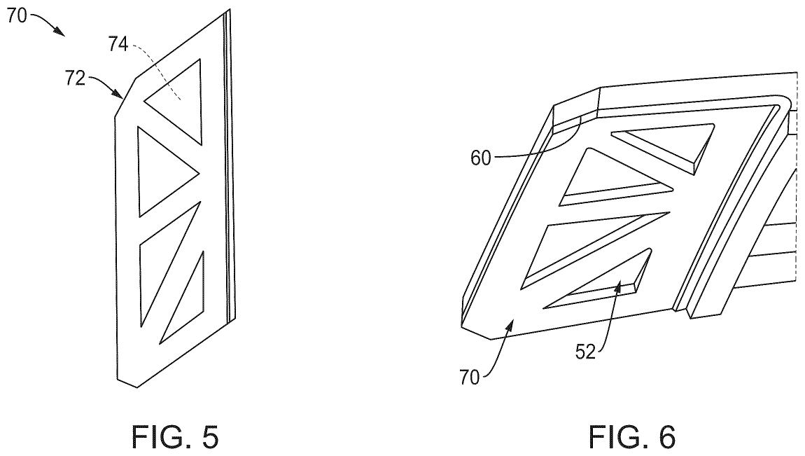

Referring now to FIGS. 2-4, a part 30 is illustrated that can be manufactured in a casting process, such as an investment casting process. Other manufacturing techniques are also contemplated as within the scope of this disclosure. For example and in accordance with the present invention, part 30 can be a ceramic matrix composite (CMC) part and manufactured using CMC processes. In at least one embodiment, the part 30 is a vane 32 such as a CMC vane of the turbine section 28 of the gas turbine engine 20 (See FIGS. 1 and 2). The vane 32 includes an inner platform 33, an outer platform 35 and an airfoil 37 disposed therebetween. More particularly, the airfoil 37 is disposed in contact proximally with the inner platform 33 and distally with the outer platform 35. Although the part 30 is illustrated as a vane 32 of the turbine section 28, the various features of this disclosure are applicable to any manufactured part of a gas turbine engine, including but not limited to vanes, stators, blades, or any other part. For example, in at least one other embodiment, the part 30 may be a blade 34 such as a CMC blade that includes an airfoil 36, and a platform 38 and a root 40 (See FIG. 3). And, for example too, in at least yet another embodiment, the part 30 may be a blade outer air seal (BOAS) 80 comprising a CMC body 82 defining a gas flow path side 84, a non-gas flow path side 86 opposite the gas flow path side 84, a forward end 88, an aft end 90, and circumferential sides 92 (See FIG. 4). CMC parts in accordance with the present invention can include Si/Si, C/SiC CMCs or the CMC materials discussed hereinbelow.

Whether the gas turbine engine component 30 is the vane 32 of FIG. 2 or the blade 34 of FIG. 3, each platform 33, 35 and 38, respectively, comprises a first exterior surface 50 and a second opposing exterior surface 52. Each airfoil 36, 37 is disposed in contact with the respective first exterior surface 50 of each platform 33, 35 and 38. And, the second opposing exterior surface 52 includes an overhang 60.

In at least one embodiment disclosed herein, at least one iso-grid reinforcement member 70 is disposed in contact with the overhang 60 (See FIGS. 4 and 5). When referring to at least one iso-grid reinforcement member 70, the number of iso-grid reinforcement members 70 utilized can vary depending on the manufacturing and/or design needs. Likewise, each iso-grid reinforcement member 70 includes an iso-grid pattern 72 containing at least one aperture 74 (See FIG. 4). The number, size and shape of each aperture 74 also can vary depending on the manufacturing and/or design needs. For example, the iso-grid reinforcement member 70 illustrated in FIG. 4 includes only four (4) apertures whose shapes are each triangular. However, the shape of each aperture 74 may be a geometric shape or a non-geometric shape or a combination thereof, and the number of apertures is not limited to four (4).

Each iso-grid reinforcement member 70 includes a CMC material comprising at least one ceramic fiber plies in at least one ceramic matrix. Exemplary ceramic matrices may include silicon-containing ceramic, such as but not limited to, a silicon carbide (SiC) matrix or a silicon nitride (Si₃N₄) matrix. Exemplary ceramic fiber plies may include silicon-containing ceramic fibers, such as but not limited to, silicon carbide (SiC) fiber or silicon nitride (Si₃N₄) fibers. In at least one exemplary embodiment, the CMC material may be, but is not limited to, a SiC/SiC ceramic matrix composite in which SiC fiber plies are disposed within a SiC matrix. In at least one exemplary embodiment, a fiber ply of each fiber plies has a fiber architecture, which refers to an ordered arrangement of, for example, fiber tows, relative to one another, such as a 2D woven ply or a 3D structure.

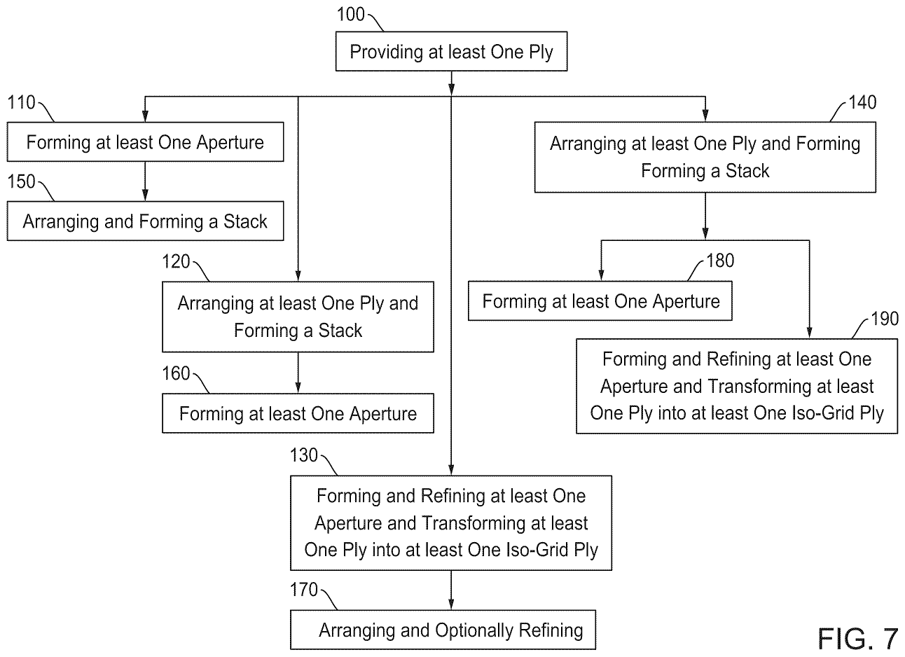

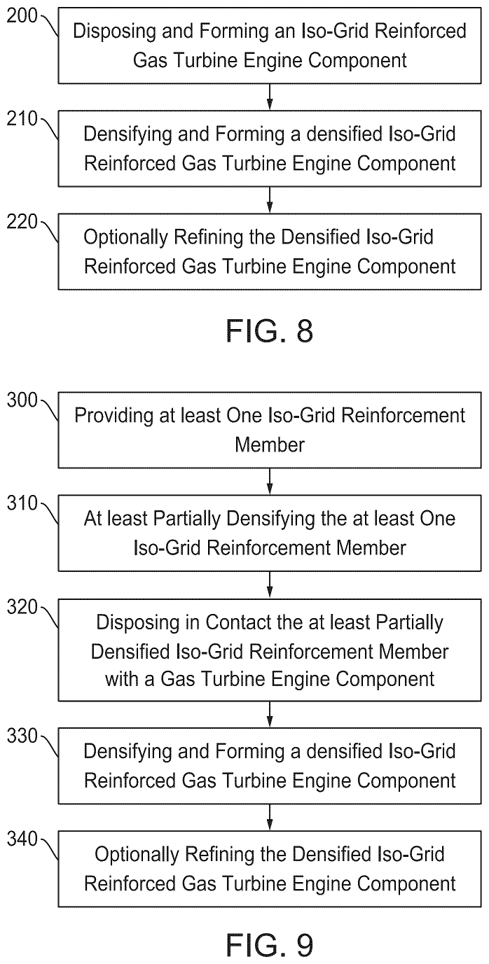

Referring now to FIGS. 7-9, a method of manufacturing at least one iso-grid ply (See FIG. 7) and a method of manufacturing a gas turbine engine component comprising an iso-grid reinforcement member (See FIGS. 8 and 9) will be discussed.

Referring specifically now to FIG. 7, a method of manufacturing at least one iso-grid ply is illustrated using a flowchart. At step 100, at least one ply comprising a ceramic matrix composite (CMC) material and a resin or a resinous material. Turning now to steps 110, 120, 130 and 140, at least one ply can be subjected to any one of the aforementioned steps 110, 120, 130 and 140. For example, at step 110, at least one aperture may be formed in each at least one ply to form at least one iso-grid ply. In at least one exemplary embodiment, forming at least one aperture may include a method, such as but not limited to, cutting at least one ply. In another example, at step 120, at least one ply can be arranged to form a stack of plies. In at least one exemplary embodiment, each ply may be laid flat upon one another, rather than along a side or edge, to form the stack. In yet another example, at step 130, at least one initial aperture is formed in each at least one ply. At least one initial aperture is then refined to form at least one aperture and, in turn, transform each at least one ply into at least one iso-grid ply. In at least one exemplary embodiment, forming at least one initial aperture may include a method, such as but not limited to, creating a pattern of initial apertures in each at least one ply. In at least one other exemplary embodiment, refining the at least one initial aperture may include a method, such as but not limited to, removing the pattern, via machining for example, from each at least one ply. In still yet another example, at step 140, at least one ply may be arranged to form a stack of plies. In at least one exemplary embodiment, each ply may be laid flat upon one another, rather than along a side or edge, to form the stack.

After performing step 110 of FIG. 7, at an additional step 150, the at least one iso-grid ply is arranged to form a stack of iso-grid plies. In at least one exemplary embodiment, arranging to form the stack may include a method, such as but not limited to, utilizing a prong tool, such as but not limited to, a forked mandrel, a forked spindle or a forked spindle mandrel. After performing step 120 of FIG. 7, at an additional step 160, at least one aperture is formed in at least one ply of the stack of plies to form a stack of iso-grid plies. In at least one exemplary embodiment, forming the at least one aperture may include a method, such as but not limited to, cutting the at least one ply of the stack of plies. After performing step 130 of FIG. 7, at an additional step 170, the at least one iso-grid ply is arranged to form a stack of iso-grid plies. Optionally, the at least one aperture of each at least one iso-grid ply may be refined in the stack of iso-grid plies. In at least one exemplary embodiment, refining the at least one aperture may include a method, such as but not limited to, machining the at least one aperture. After performing step 140 of FIG. 7, at an additional step 180, at least one aperture may be formed in at least one ply of the stack of plies to form at least one iso-grid ply of a stack of iso-grid plies. In the alternative, after performing step 140 of FIG. 7, at an additional step of 190, at least one initial aperture may be formed in each at least one ply of the stack of plies. At least one initial aperture then may be refined to form at least one aperture, and each at least one ply of the stack of plies may be transformed into at least one iso-grid ply of a stack of iso-grid plies.

Referring specifically now to FIG. 8, a method of manufacturing a gas turbine engine component, such as but not limited to, a blade, a vane, a stator, or other similar gas turbine engine component, comprises an iso-grid reinforcement member is illustrated using a flowchart. At step 200, at least one iso-grid ply is disposed in contact with an overhang of the second opposing exterior surface of at least one platform having an airfoil attached thereto to form an iso-grid reinforced gas turbine engine component. Next, at step 210, the iso-grid reinforced gas turbine engine component is densified using a method, such as but not limited to, at least one of or a combination of chemical vapor infiltration, chemical vapor deposition, polymer infiltration and pyrolysis, and melt infiltration, to form a densified iso-grid reinforced gas turbine engine component comprising at least one iso-grid reinforcement member. Next, and optionally at step 220, the densified iso-grid reinforced gas turbine engine component is refined. In at least one exemplary embodiment, refining the densified iso-grid reinforced gas turbine engine component may include a method, such as but not limited to, machining.

Referring specifically now to FIG. 9, a method of manufacturing a gas turbine engine component, such as but not limited to, a blade, a vane, a stator, or other similar gas turbine engine component, comprises an iso-grid reinforcement member is illustrated using a flowchart. At step 300, at least one iso-grid reinforcement member is provided. At step 310, at least one iso-grid reinforcement member is at least partially densified. At step 320, at least one iso-grid ply or at least one partially densified iso-grid ply is disposed in contact with an overhang of the second opposing exterior surface of at least one platform having an airfoil attached thereto to form an iso-grid reinforced gas turbine engine component. Next, at step 330, the iso-grid reinforced gas turbine engine component is densified using a method, such as but not limited to, at least one of or a combination of chemical vapor infiltration, chemical vapor deposition, polymer infiltration and pyrolysis, and melt infiltration, to form a densified iso-grid reinforced gas turbine engine component comprising at least one iso-grid reinforcement member. Next, and optionally at step 340, the densified iso-grid reinforced gas turbine engine component is refined. In at least one exemplary embodiment, refining the densified iso-grid reinforced gas turbine engine component may include a method, such as but not limited to, machining.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. A gas turbine engine component, comprising:
an airfoil;
at least one platform comprising a first exterior surface and a second opposing exterior surface, wherein the airfoil is disposed in contact with the first exterior surface; and
at least one iso-grid reinforcement member disposed in contact with the second opposing exterior surface,
wherein the at least one iso-grid reinforcement member comprises at least one aperture having a geometric shape or a non-geometric shape or a combination thereof.

2. The gas turbine engine component of claim 1, wherein the gas turbine engine component comprises a blade.

3. The gas turbine engine component of claim 1, wherein the gas turbine engine component comprises a vane, the at least one platform comprises an inner platform and an outer platform, and the airfoil is disposed in contact proximally with the inner platform and distally with the outer platform.

4. The gas turbine engine component of claim 1, wherein the second opposing exterior surface comprises an overhang, and the at least one iso-grid reinforcement member is disposed in contact with the overhang.

5. The gas turbine engine component of claim 1, wherein the iso-grid reinforcement member comprises a ceramic matrix composite (CMC) material.

6. A gas turbine engine component, comprising:
an airfoil;
at least one platform comprising a first exterior surface and a second opposing exterior surface, wherein the airfoil is disposed in contact with the first exterior surface; and
at least one iso-grid reinforcement member in a preform state disposed in contact with the second opposing exterior surface.

7. The gas turbine engine component of claim 6, wherein the at least one iso-grid reinforcement member in a preform state comprises at least one aperture having a geometric shape or a non-geometric shape or a combination thereof.

8. The gas turbine engine component of claim 6, wherein the gas turbine engine component comprises a blade.

9. The gas turbine engine component of claim 6, wherein the gas turbine engine component comprises a vane, the at least one platform comprises an inner platform and an outer platform, and the airfoil is disposed in contact proximally with the inner platform and distally with the outer platform.

10. The gas turbine engine component of claim 6, wherein the second opposing exterior surface comprises an overhang, and the at least one iso-grid reinforcement member is disposed in contact with the overhang.

11. A gas turbine engine component, comprising:
a blade outer air seal comprising a body defining a gas flow path side, a non-gas flow path side opposite the gas flow path side, a forward end, an aft end, and at least one circumferential side; and
at least one iso-grid reinforcement member disposed in contact with the non-gas flow path side,
wherein the at least one iso-grid reinforcement member comprises at least one aperture having a geometric shape or a non-geometric shape or a combination thereof.

12. The gas turbine engine component of claim 11, wherein the body comprises a ceramic matrix composite (CMC) material.

13. A gas turbine engine component, comprising:
a blade outer air seal comprising a body defining a gas flow path side, a non-gas flow path side opposite the gas flow path side, a forward end, an aft end, and at least one circumferential side; and
at least one iso-grid reinforcement member in a preform state disposed in contact with the non-gas flow path side.

14. The gas turbine engine component of claim 13, wherein the at least one iso-grid reinforcement member in a preform state comprises at least one aperture having a geometric shape or a non-geometric shape or a combination thereof.

15. The gas turbine engine component of claim 13, wherein the body comprises a ceramic matrix composite (CMC) material.

16. A method of manufacturing at least one iso-grid ply, comprising:
providing at least one ply in a preform state comprising a ceramic matrix composite (CMC) material and a resin or a resinous material, and any one of the following steps:
(i) forming at least one aperture in each at least one ply in a preform state to form at least one iso-grid ply in a preform state;
or
(ii) arranging at least one ply in a preform state to form a stack of plies in a preform state;
or
(iii) forming at least one initial aperture in each at least one ply in a preform state and refining the at least one initial aperture to form at least one aperture and transform each at least one ply in a preform state into at least one iso-grid ply in a preform state; and
further comprising an additional step of:
after performing (i), arranging at least one iso-grid ply in a preform state to form a stack of iso-grid plies in a preform state;
or
after performing (ii), performing either the step of (iia) forming at least one aperture in at least one ply in a preform state of the stack of plies in a preform state to form at least one iso-grid ply in a preform state of a stack of iso-grid plies in a preform state, or the step of (iib) forming at least one initial aperture in each at least one ply in a preform state of the stack of plies in a preform state and refining the at least one initial aperture to form at least one aperture and transform each at least one ply in a preform state of the stack of plies in a preform state into at least one iso-grid ply in a preform state of a stack of iso-grid plies in a preform state;
or
after performing (iii), arranging at least one iso-grid ply in a preform state to form a stack of iso-grid plies in a preform state and optionally refining the at least one aperture of each at least one iso-grid ply in a preform state in the stack of iso-grid plies in a preform state.

17. The method of claim 16, wherein the at least one aperture comprises a geometric shape or a non-geometric shape or a combination thereof.

18. The method of claim 16, wherein forming at least one aperture of (i) comprises cutting the at least one ply in a preform state.

19. The method of claim 16, wherein forming at least one initial aperture of (iii) comprises creating a pattern of initial apertures in each at least one ply in a preform state.

20. The method of claim 19, wherein refining the at least one initial aperture of (iii) comprises removing the pattern from each at least one ply in a preform state.

21. The method of claim 16, wherein arranging at least one iso-grid ply in a preform state to form a stack of iso-grid plies comprises using a prong tool.

22. The method of claim 16, wherein forming at least one aperture in each at least one ply in a preform state of the stack of plies in a preform state to form a stack of iso-grid plies in a preform state comprises cutting at least one ply in a preform state of the stack of plies in a preform state.

23. A method of manufacturing a gas turbine engine component comprising an iso-grid reinforcement member, comprising:
disposing in contact at least one iso-grid ply in a preform state or at least one partially densified iso-grid reinforcement member with at least one platform having an airfoil attached thereto to form an iso-grid reinforced gas turbine engine component;
densifying the iso-grid reinforced gas turbine engine component using at least one of or a combination of chemical vapor infiltration, chemical vapor deposition, polymer infiltration and pyrolysis, and melt infiltration, to form a densified iso-grid reinforced gas turbine engine component comprising at least one iso-grid reinforcement member; and
optionally, refining the densified iso-grid reinforced gas turbine engine component.

24. The method of claim 23, wherein the at least one platform comprises a first exterior surface and a second opposing exterior surface, the airfoil is attached to the first exterior surface, wherein the second opposing exterior surface comprises an overhang, and the at least one iso-grid ply is disposed in contact with the overhang.

25. The method of claim 23, wherein the at least one iso-grid ply in a preform state comprises at least one aperture having a geometric shape or a non-geometric shape or a combination thereof.

26. The method of claim 23, wherein the gas turbine engine component comprises a blade.

27. The method of claim 23, wherein the gas turbine engine component comprises a vane, the at least one platform comprises an inner platform and an outer platform, and the airfoil is disposed in contact proximally with the inner platform and distally with the outer platform.

28. The method of claim 23, wherein prior to disposing in contact at least one partially densified iso-grid reinforcement member, performing the following steps comprising:
providing at least one iso-grid reinforcement member in a preform state and at least partially densifying the at least one iso-grid reinforcement member to form the at least partially densified iso-grid reinforcement member.

29. The method of claim 23, wherein the at least one iso-grid ply in a preform state comprises a ceramic matrix composite (CMC) material and a resin or a resinous material.

30. A method of manufacturing a gas turbine engine component comprising an iso-grid reinforcement member, comprising:
disposing in contact at least one iso-grid ply in a preform state or at least one partially densified iso-grid reinforcement member with at least one non-gas flow path side of at least one blade outer air seal to form an iso-grid reinforced gas turbine engine component;
densifying the iso-grid reinforced gas turbine engine component using at least one of or a combination of chemical vapor infiltration, chemical vapor deposition, polymer infiltration and pyrolysis, and melt infiltration, to form a densified iso-grid reinforced gas turbine engine component comprising at least one iso-grid reinforcement member; and
optionally, refining the densified iso-grid reinforced gas turbine engine component.

31. The method of claim 30, wherein the at least one iso-grid ply in a preform state comprises at least one aperture having a geometric shape or a non-geometric shape or a combination thereof.

32. The method of claim 30, wherein prior to disposing in contact at least one partially densified iso-grid reinforcement member, performing the following steps comprising: providing at least one iso-grid reinforcement member in a preform state and at least partially densifying the at least one iso-grid reinforcement member to form the at least partially densified iso-grid reinforcement member.

33. The method of claim 30, wherein the at least one iso-grid ply in a preform state comprises a ceramic matrix composite (CMC) material and a resin or a resinous material.
